(19) United States
(12) Patent Application Publication
(10) Pub. No.: US 2018/0252868 A1
(43) Pub. Date: Sep. 6, 2018

(54) METHOD AND SYSTEM FOR FIBER-COUPLED, LASER-ASSISTED IGNITION IN FUEL-LEAN, HIGH-SPEED FLOWS

(71) Applicant: Government of the United States as Represented by the Secretary of the Air Force, Wright-Patterson AFB, OH (US)

(72) Inventors: James R. Gord, Beavercreek, OH (US); Sukesh Roy, Dayton, OH (US); Paul S. Hsu, Dayton, OH (US); Zhili Zhang, Knoxville, TN (US)

(73) Assignee: Government of the United States as Represented by the Secretary of the Air Force, Wright-Patterson AFB, OH (US)

(21) Appl. No.: 15/910,373

(22) Filed: Mar. 2, 2018

Related U.S. Application Data
(60) Provisional application No. 62/466,599, filed on Mar. 3, 2017.

(51) Int. Cl. G02B 6/32; G02B 6/42; H01P 3/20; F02P 23/04

(52) U.S. Cl. CPC G02B 6/325; G02B 6/4204; H05H 1/46; G02B 6/4268; F02P 23/045; H01P 3/20

(57) ABSTRACT

A laser ignition system. The system includes a laser, a lens, and a fiber optic cable. The laser is configured to generate pulses having a length ranging from about 10 ns to about 30 ns and pulse energy ranging from about 10 mJ to about 20 mJ. A pulse train may comprise a plurality of the pulses with a repetition rate of greater than 10 kHz. The lens is configured to focus the pulses toward a combustible fluid so as to ignite a plasma. The fiber optic cable extends between the laser and the lens.

Pursuant to 37 C.F.R. § 1.78(a)(4), this application claims the benefit of and priority to prior filed co-pending Provisional Application Ser. No. 62/466,599, filed Mar. 3, 2017, which is expressly incorporated herein by reference in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to laser ignition and, more particularly, to methods and devices associated with laser ignition.

### BACKGROUND OF THE INVENTION

Laser ignition (“LI”) is an ignition method that has certain advantages over traditional electric spark plugs and gaseous torches for fuel-lean, high-pressure ignition environments. LI provides precise ignition timing, large penetration depth, and ignition at a desired location for optimal combustion performance. LI has been used for a wide variety of applications, including ignition of gaseous fuels for internal combustion (“IC”) engines and rocket engines and initiation of nuclear fission/fusion reactions. Of particular interest is the use of LI for stationary gas turbine engines because of the possibility of increased engine efficiency and reduced NOx emission. Also of interest is the use of laser sparks for ignition of aircraft gas turbine engines to achieve rapid relight.

Among the available LI methods, the nonresonant-breakdown LI technique has been the most widely used because of its ease of implementation and rapid ignition. For nonresonant-breakdown LI, seed electrons are generated through nonresonant, multi-photon ionization processes using a high-intensity laser pulse—with the caveat that an intensity of the ionization must exceed an air breakdown threshold of about 10¹¹ W/cm². Subsequently, the electrons are accelerated via an inverse Bremsstrahlung process using the same high-intensity laser pulse. Collisions between the accelerated electrons and other, nearby molecules liberate additional electrons and induce an electron avalanche capable of forming a large, laser-induced plasma. Joule heating of a surrounding combustible gaseous mixture and a production of highly reactive chemical intermediates ultimately lead to ignition.

For nonresonant-breakdown LI, the high-intensity laser pulse is generated by a conventional, high-energy, 10 ns duration laser pulse generated by a 10 Hz to 20 Hz Nd:YAG laser. While dependent on focusing geometries and gas mixtures, a minimum ignition energy (“MIE”) is generally ranges from about 10 mJ/pulse to about 20 mJ/pulse for natural gas engines or from about 30 mJ/pulse to about 60 mJ/pulse for aero-turbine engines. The MIE increases significantly when the fuel/air mixture becomes lean with an equivalence ratio: ϕ<0.7. MIE also increases with the gas flow rate and gas flow turbulence.

Despite these advancements in conventional LI techniques, implementation on practical engines and IC devices, where optical access is typically limited, still faces challenges. Over the past decade, researchers have attempted to develop a fiber-optic beam delivery system suitable for use in LI. However, because of the high-energy requirements for individual pulses, delivery of the required laser beam intensity via a flexible optical fiber has not been realized. For example, a solid-core, silica fiber having a large core diameter (about 0.4 mm) is capable of transmitting about 10 mJ/pulse, which is barely sufficient for ignition. Hollow-core fibers are capable of transmitting higher laser energies per pulse, and have been used for ignition. However, the hollow-core fibers are very sensitive to bending loss and, thus, are not ideal for practical applications. Still other commercially-available optical fibers have been investigated for LI application in IC engines; however, the results of these studies have concluded that significant advances in optical fiber development are needed to achieve reliable, single-pulse LI for real-world engine applications.

Recently, the delivery of high-energy laser pulses (about 4 mJ/pulse of 10 ns duration or about 30 mJ/pulse of 30 ns duration) for ignition of a combustible mixture at near-stoichiometric conditions (0-1) was demonstrated using hollow-core kagome photonic crystal fibers. However, such advancements are unable to overcome the need for achieving LI in fuel-lean, high-speed flows while not exceeding the fiber-damage threshold.

Dual-pulse approaches (i.e., two pulses having a pulse spacing ranging from about 10 ns to about 200 ns) have been used to enhance ignition in lean fuel/air mixtures. Such research has found that extension of the laser-spark lifetime and optimization of local-energy eposition are highly dependent on the pulse spacing. For example, in atmospheric pressure air, plasma enhancement has been achieved with two pulses separated by more than 50 μs.

Therefore, remains a need for LI methods and devices sufficient to achieve ignition in fuel-lean and high-speed flows. Further, there is a need for such LI methods and devices to be operable with optical fibers without causing damage thereto.

### SUMMARY OF THE INVENTION

The present invention overcomes the foregoing problems and other shortcomings, drawbacks, and challenges of achieving LI in fuel-lean, high-speed flows, without damage to optical fibers. While the invention will be described in connection with certain embodiments, it will be understood that the invention is not limited to these embodiments. To the contrary, this invention includes all alternatives, modifications, and equivalents as may be included within the spirit and scope of the present invention.

According to embodiments of the present invention, a laser ignition system that includes a laser, a lens, and a fiber optic cable. The laser is configured to generate pulses having a length ranging from about 10 ns to about 30 ns and pulse energy ranging from about 10 mJ to about 20 mJ. A pulse train may comprise a plurality of the pulses with a repetition rate of greater than 10 kHz. The lens is configured to focus the pulses toward a combustible fluid so as to ignite a plasma. The fiber optic cable extends between the laser and the lens.

Other embodiments of the present invention include an ignitor for use with a laser ignition system that is configured to generate pulses having a length ranging from about 10 ns to about 30 ns, pulse energy ranging from about 10 mJ to about 20 mJ, and a pulse train of these pulses with a repetition rate of greater than 10 kHz. The ignitor includes a fiber optic collimator, a first optical fiber, and a first lens. The first optic collimator is configured to focus the pulse train to a desired plasma location. The first optical fiber is configured to transfer the pulse train from the laser ignition system to the fiber optic collimator. The first lens is configured to isolate heat after a plasma is formed at the desired plasma location.

Still other embodiments of the present invention are directed to a laser ignition assembly that includes a laser ignition system and an ignitor. The laser ignition system includes a laser configured to generate pulses having a length ranging from about 10 ns to about 30 ns, pulse energy ranging from about 10 mJ to about 20 mJ, and a pulse train of these pulses with a repetition rate of greater than 10 kHz. The ignitor includes a fiber optic collimator, a first optical fiber, and a first lens. The first optic collimator is configured to focus the pulse train to a desired plasma location. The first optical fiber is configured to transfer the pulse train from the laser ignition system to the fiber optic collimator. The first lens is configured to isolate heat after a plasma is formed at the desired plasma location.

According to still other embodiments of the present invention, a laser ignition assembly includes a laser ignition system, a microwave generator, a fiber optic cable, and an ignitor. The laser ignition system includes a laser configured to generate pulses having a length ranging from about 10 ns to about 30 ns, pulse energy ranging from about 10 mJ to about 20 mJ, and a pulse train of these pulses with a repetition rate of greater than 10 kHz. The fiber optic cable is configured to transfer the pulse train from the laser to the ignitor. The ignitor includes a housing, a fiber optic collimator, a first optical fiber, a first lens, a second optical fiber, and a microwave wave guide. The housing has a first end, a second end, and a lumen extending therebetween. The fiber optic collimator is positioned within the lumen, proximate to the second end, and is configured to focus the pulse train to a desired plasma location. The first optical fiber is positioned within the lumen and is configured to transfer the pulse train from the fiber optic cable to the fiber optic collimator. The first lens is positioned within the lumen, proximate to the second end, and is configured to isolate heat after a plasma is formed at the desired plasma location. The second optical fiber is positioned within the lumen and is configured to transfer microwaves from the microwave generator to the desired plasma location. The microwave wave guide is positioned within the lumen and is configured to focus microwaves to the desired plasma location.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 side elevational schematic view of an LI assembly according to an embodiment of the present invention.

FIG. 2 is a longitudinal, cross-sectional view of an ignitor suitable for use with the LI assembly of FIG. 1 and in accordance with an embodiment of the present invention.

FIG. 3 is another cross-sectional view of the ignitor of FIG. 2.

FIG. 4 is an enlargement of the portion enclosed in FIG. 2, shown in partial cross-section.

FIG. 5 is a side elevational view of a housing of the ignitor of FIG. 2, shown in partial cross-section.

FIG. 6 is a perspective view of a laboratory setup of the LI assembly of FIG. 1 according to an embodiment of the present invention.

FIG. 7 is schematic view of the laboratory set up of FIG. 6.

FIG. 8 is a laser pulse train of an incident laser beam for laser-induced spark with a 3 ms amplifier operation.

FIG. 9 graphically illustrates increased plasma density over the time span of the laser pulse train of FIG. 8.

FIGS. 10A-12J are chemiluminescence images of the isobutene/air mixture at an equivalence ratio of ϕ=1 using single shot, 10 Hz laser, and a high-repetition rate.

FIG. 13 graphically illustrates exemplary minimum ignition energy as a function of pulse repetition rate.

FIG. 14 graphically illustrates exemplary minimum ignition energy as a function of equivalence ratio of an ethylene/air mixture.

FIG. 15 graphically illustrates an ignition probability of an isobutene/oxygen/nitrogen mixture by pulse trains of differing repetition rates.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

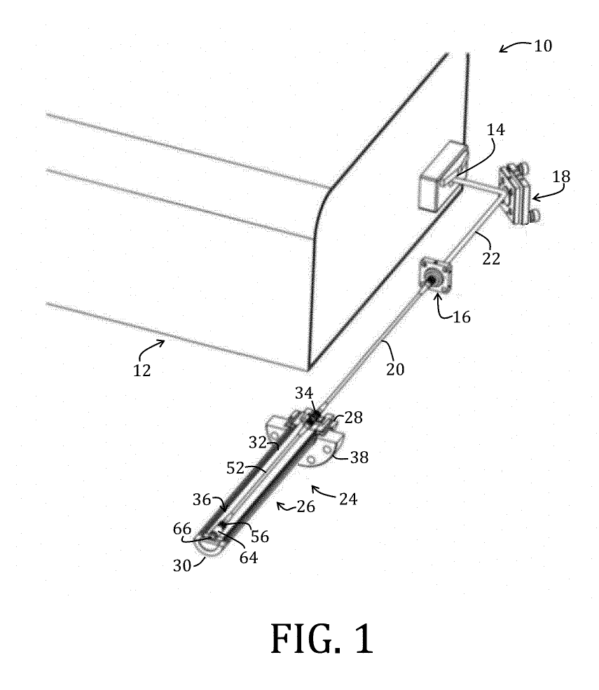

Referring now to the figures, and in particular to FIG. 1, an LI assembly 10 according to an embodiment of the present invention is shown. The LI assembly 10 includes an energy source 12, which as specifically illustrated, may be a laser 12 operated in burst-mode such that laser pulses are provided at a high-frequency pulse-rate (hereafter, “pulse train”). While the specific wavelength and power of the laser pulses comprising the pulse train may vary as would be determined by one of ordinary skill in the art having the benefit of the disclosure provided herein (for example, given a fundamental of 1064 nm or second harmonic of 532 nm, power ranging from 1 mJ/pulse to 10 mJ/pulse would be sufficient), any suitable laser operated in burst mode by applying a shutter or powering off after a burst time may be used. One suitable, commercially-available laser may be a Quasimodo Nd:YAG laser (Spectral Energies, Dayton, Ohio), which is configured to provide a second-harmonic generation from a 1064 nm output of the burst-mode laser yielding 532 nm, 10 ns laser pulses having a repetition rate ranging from 10 kHz to 100 kHz. While not specifically illustrated in FIG. 1, a polarizer, a half-wave plate, or both may also or alternatively be used for controlling pulse energy within each burst of pulses or energy of the burst.

After generation, the pulse train leaving an output 14 of the laser 12 may be directed into a laser-to-fiber coupler 16, optionally by way of one or more mirrors 18. The coupler 16 may be any suitable and commercially-available laser-to-fiber coupler having high-efficiency and configured to receive the pulse train. One exemplary laser-to-fiber coupler may be the laser-to-fiber couple with adjustable focus by Oz Optics, Ltd. (Ottawa, ON, Canada), which is described in greater detail in U.S. Pat. No. 7,431,513. Generally, the coupler 16 operates by focusing the pulse train transmitted along a light path 22 onto a receiving end (not shown) of a fiber optic cable 20, which transmits the pulse train to an ignitor 24.

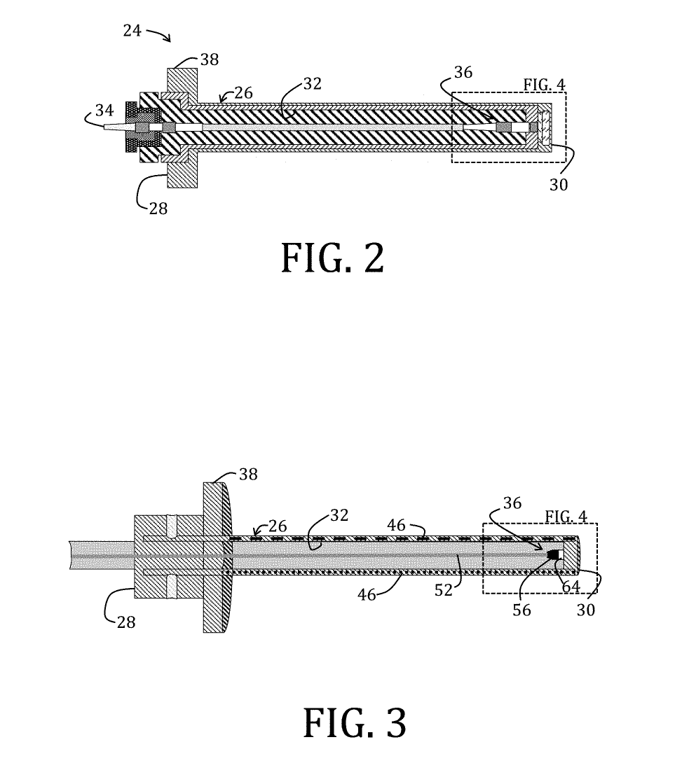

The ignitor 24, illustrated in greater detail in FIGS. 2-5, configured to provide laser pulses for the multi-point ignition at a combustor (not shown), includes a housing 26 having a first end 28, a second end 30, and a lumen 32 extending therebetween. A fiber optic coupler 34 extends through the first end 28 of the housing 26, and a fiber ignition coupler 36 is positioned within the lumen 32, proximate to the second end 30 of the housing 26. As illustrated, the housing 26 includes a flange 38 configured to secure the ignitor 24 at a position suitable for use with the combustor (not shown); however, such flange 38 is not required. A bore 40 and counterbore 42, proximate to the fiber ignition coupler 36, are provided within the second end 30 of the housing 26 for plasma formation.

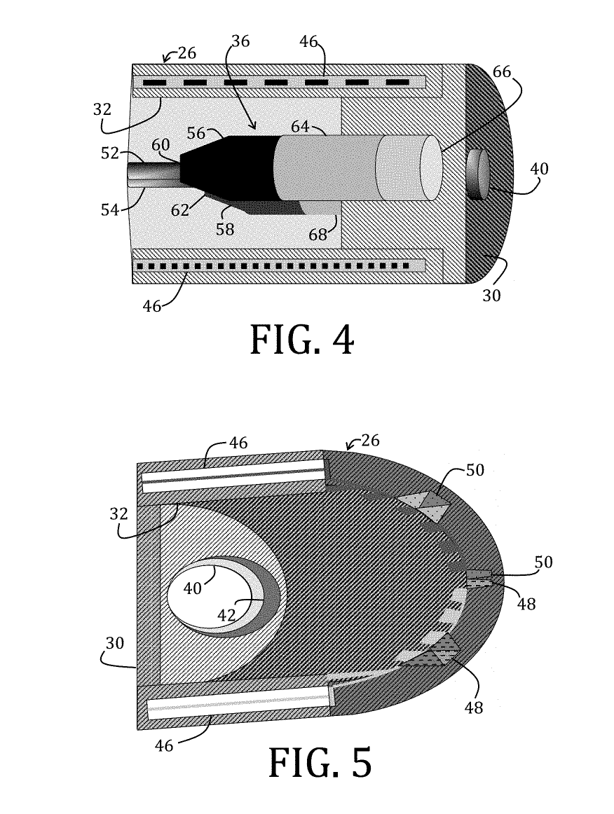

FIGS. 3 and 4 specifically illustrate a plurality of channels 44 within the housing 26 and extending a length thereof, and which are in fluid communication with a plurality of coolant channels 46 (wherein influent channels include dotted, coolant lines and effluent channels include dashed, effluent lines in FIGS. 3 and 4 and are light and dark lines, respectively, in FIG. 5). As such, a coolant (water, air, nitrogen gas, and so forth) may flow into the coolant channels 46 by way of one or more inflow channels 48 (FIG. 5), flow along the channels 46, and ultimately exit the channels 46 at an outflow channels 50 (FIG. 5). Accordingly, the ignitor 24 is equipped for cooling so as to sustain temperatures over 2500 K, which are typical of combustors. The number of coolant channels 46 may therefore be determined by one having ordinary skill in the art having the benefit of the disclosure provided herein and knowing temperature conditions in which the ignitor 24 may be exposed. Further control of cooling may be provided by altering a temperature of the coolant entering the coolant channels 46 at the inflow channel 48, a flow rate of the coolant, or a chemical composition of the particular coolant (such as by altering a heat capacity of the coolant).

The fiber optic coupler 34, extending through the first end 28 of the housing 26, may be any suitable, commercially-available coupling system configured to receive the fiber optic cable 20 (FIG. 1) of the assembly 10 (FIG. 1) and to provide improved fiber damage threshold and endurance. The housing 26 may be designed to evacuate air from the fiber optic entrance of the first end 28 so as to avoid plasma generation near a fiber core. The optical signal, at the fiber optic coupler 34 and within the lumen 32 of the housing 26, is split between first and second optical fibers 52, 54 extending through the lumen 32 of the housing 26 between the fiber optic coupler 34 and the fiber ignition coupler 36.

Referring specifically now to FIG. 4, with reference to FIGS. 2, 3, and 5, the fiber ignition coupler 36 is described in greater detail. Generally, the fiber ignition coupler 36 includes first and second focus assemblies 56, 58 coupled to distal ends 60, 62 of the first and second optical fibers 52, 54, respectively. The first focus assembly 56 focuses its respective optical signal to a fiber optic collimator 64, which is coupled to a lens 66 (constructed from sapphire, quartz, or other glass material). The fiber optic collimator focuses the pulse train to a desired plasma location while the lens isolates heat after plasma formation at the desired plasma location.

The second focus assembly 58 focuses its respective optical signal to a microwave wave guide 68, which is coupled to a lens (not show), which may be the same lens 66 associated with the fiber optic collimator 64 or a separate and distinct lens. Although not specifically shown, high-power microwaves, by way of the second focus assembly 58, be used to enhance laser ignition performance and to reduce required laser energy by 20%. However, microwave enhancement has limited working distance (ranging from 1 mm to 10 mm). Therefore, if microwave enhancement is used with traditional 10 Hz laser-based ignition, then the required energy may still exceed the damage threshold of conventional, commercially-available fibers. The microwaves may be generated by a microwave source (not shown), such as one having about 1.5 kW power, and delivered with by WR 284 waveguides (not shown). Such microwave energy would be sufficient to deposit energy into the hot ignition core (i.e., the plasma created by laser) for enhancing the ignition performance (e.g., further lower the required laser energy, increase ignition success probability).

In use, the burst-mode laser generates a high-repetition-rate nanosecond pulse train for efficient laser ignition with low per-pulse energy. In the pulse train, the first pulse generates a weakly ionized plasma, which serves as a seeding medium for deposition of additional laser pulse energy. Subsequent nanosecond pulses (with the same pulse duration as the first pulse, with 3 to 5 pulses being typical) with a pulse spacing ranging from 10 ms to 100 ms serve to grow the plasma resulting in ignition. The low-energy pulses generated from the burst-mode laser may be fiber-coupled through the designed high-temperature fiber-coupled laser ignitor for laser ignition at a desired location in a combustion facility under high-pressure, high-flow-rate, and high-temperature conditions.

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

### EXAMPLE 1

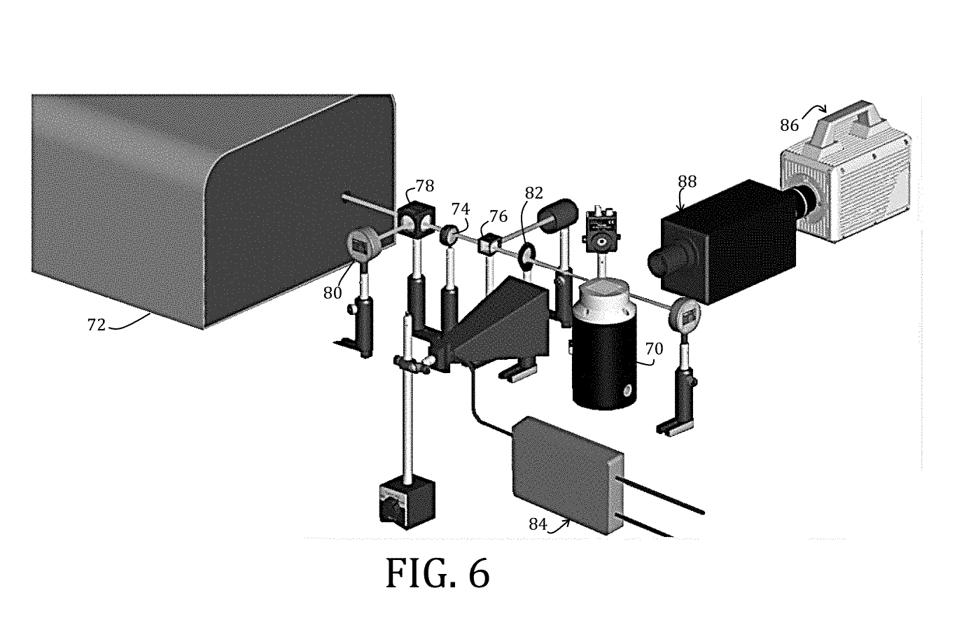

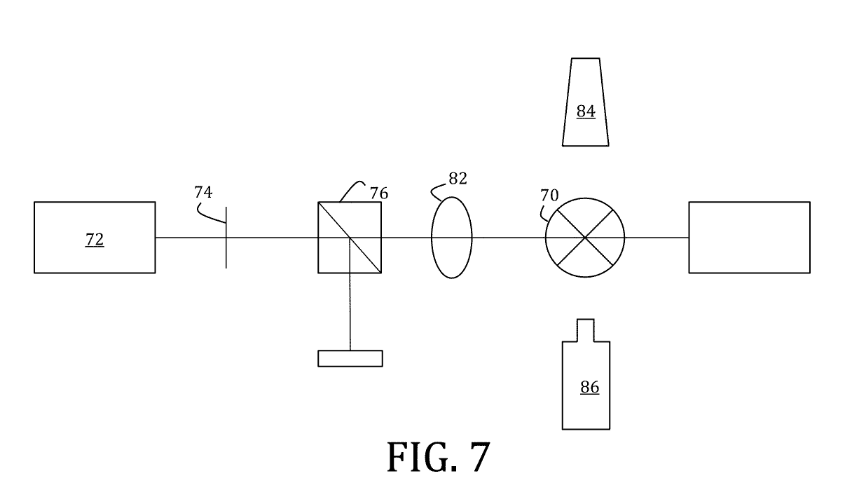

A laser assembly suitable to achieve laser ignition of a combustible mixture, such as may be used with the LI assembly of FIG. 1, is shown in perspective in FIG. 6 and in schematic in FIG. 7. A combustible mixture of isobutene and air with ethylene and air flows were used and stabilized on an atmospheric-pressure Hencken burner 70. Isobutane and ethylene fuels are commonly used in hypersonic wind tunnels and IC devices.

An Nd:YAG-based laser 72 (Quasimodo by Spectral Energies Ltd.) operated in burst-mode generates high-repetition-rate pulses. Second-harmonic generation from a 1064 nm output of the burst-mode laser yields 532 nm, 10 ns laser pulses having a repetition rate ranging from 10 kHz to 100 kHz. Pulse energy of the emitted pulse train may be controlled by a half-wave plate 74 and a polarizer 76. As shown in FIG. 7, a beam splitter 78 is used to direct at least a portion of the pulse train to a power meter 80.

A spherical lens 82, having a focal length of 50 mm, focuses the pulse train onto a center of the Hencken burner 70. A beam waist at the focal point was measured with a beam profiler and found to be about 60 μm.

To characterize laser-plasma interaction during the LI process, an electron number density in a generated plasma was detected by coherent microwave scattering using a microwave detector 84.

A high-speed camera 86 (FASTCAM SA-Z by Photron USA, Inc., San Diego, Calif.) coupled to an external, two-stage intensifier 88 (HS-IRO by LaVision GmbH, Goettingen, Germany) was employed to record chemiluminescence from hydroxyl radicals (“OH*”). Chemiluminescence was collected around 310 nm with a CERCO UV 45 mm, f/1.8 lens (Sodern, Cedex, France). OH* chemiluminescence was utilized to identify the flame reaction zone and capture the flame front and propagation. To minimize signal interference from flame emission and plasma emission, a BRIGHTLINE, narrow-bandpass filter (not shown) (FF01-320/40-50 by Semrock, Inc., Rochester, N.Y.) was placed near an imaging lens of the high-speed camera. The two-dimensional, OH* chemiluminescence images were acquired with about 2 μs exposure time. Ignition delays and reaction times were determined from these measurements.

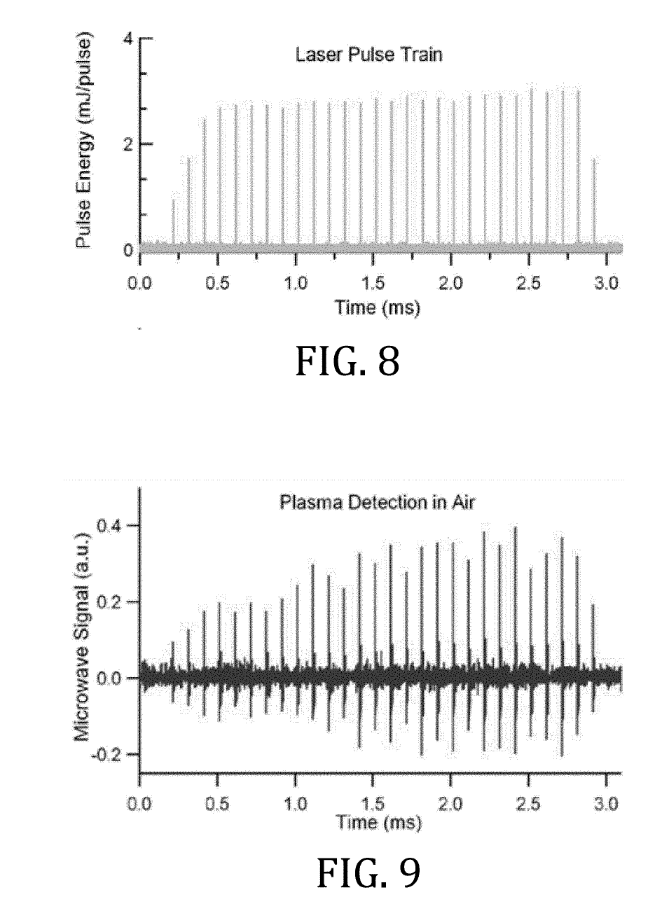

Referring now to FIG. 8, a burst profile of incident laser beam for laser-induced spark with a 3 ms amplifier operation for repetition rate of 10 kHz (532 nm), indicates a first pulse generates a weakly ionized plasma, which acted as a gain medium for further energy deposition through inverse-Bremsstrahlung and avalanche ionization processes by the proceeding pulses. Because the overall plasma lifetime at atmospheric pressure (ranging from about 100 μs to about 150 μs, depending on air temperature and humidity) is longer than the temporal spacing of the 10 kHz pulse train, the density of the initial, weak plasma was greatly enhanced by the subsequent pulses. This increased plasma density is observed over the time span of the pulse train in the corresponding microwave-scattering signals within 10 kHz pulse train graphically illustrated in FIG. 9.

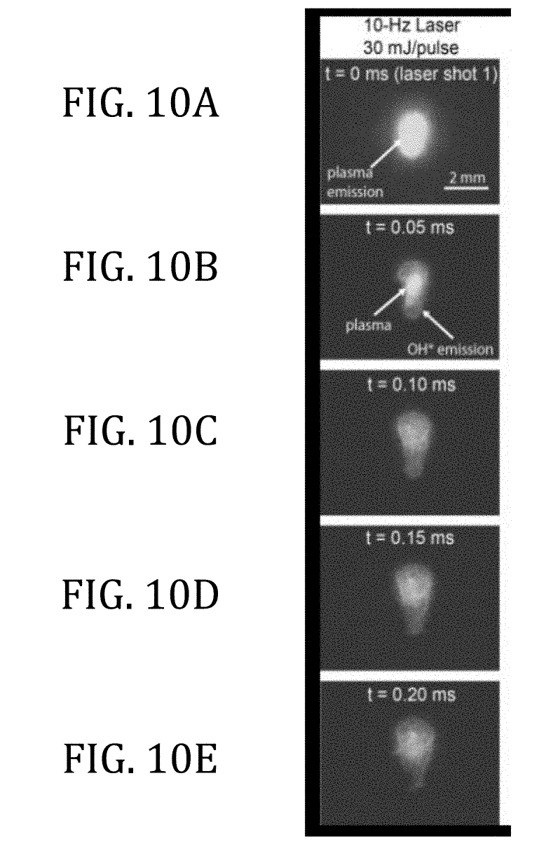

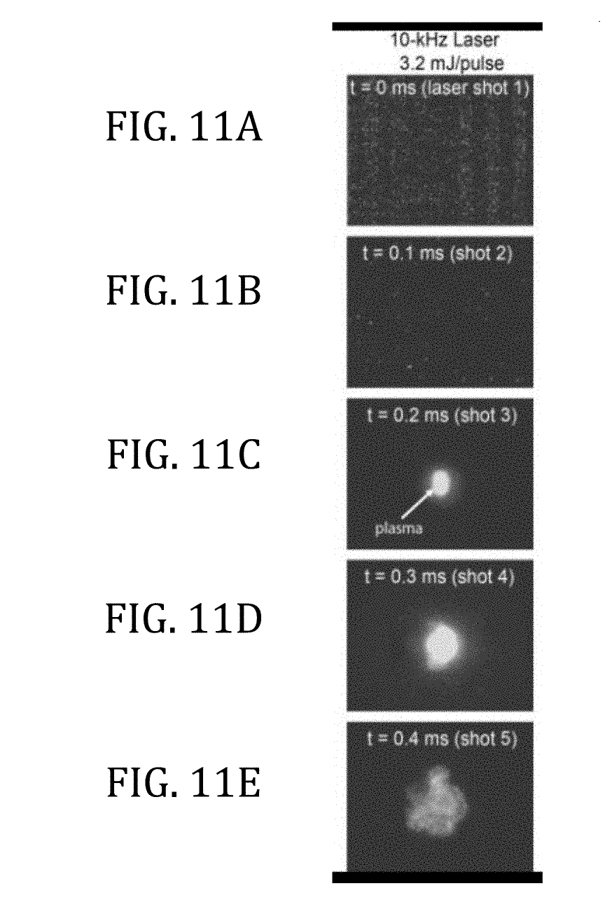

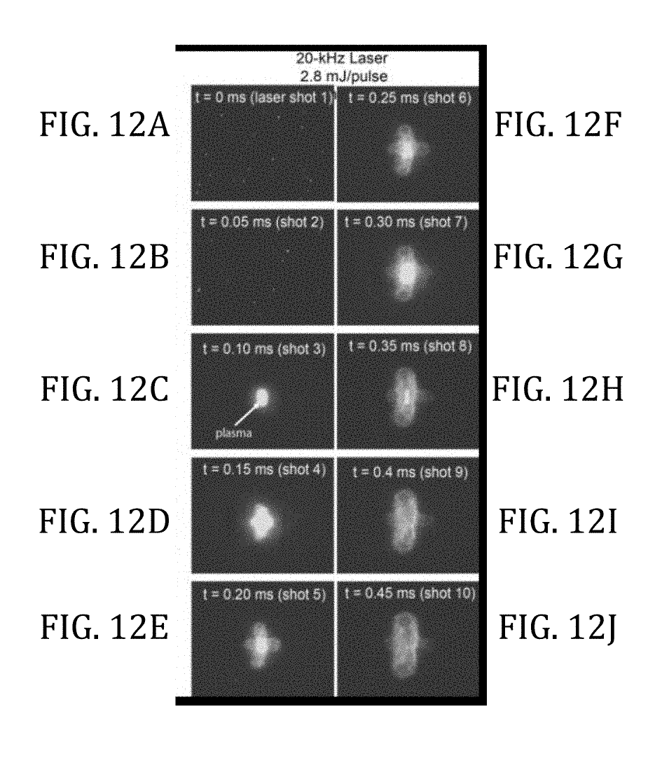

FIGS. 10A-12J are chemiluminescence images of the isobutene/air mixture (above the Hencken burner) at equivalence ratio of ϕ=1 using 10 Hz laser (single shot) and high-repetition rate laser (10 kHz and 20 kHz with 0.5 mx burst duration). These images illustrate a transfer of thermal energy, through a thermalization process, from hot electrons in the enhanced plasma to ambient gases. The process eventually lead to localized thermal runaway and ignition in the combustible mixture. The flow and beam conditions (i.e., a focused beam diameter, fuel/air mixture, and flow rate) were consistent for FIGS. 10A-10E, FIG. 11A-11E, and 12A-12J. The pulse energy used for ignition for the 10 Hz laser, the 10 kHz laser, and 20 kHz laser was about 30 mJ/pulse, about 3.2 mJ/pulse, and about 2.8 mJ/pulse, respectively. Bright yellow spots in FIGS. 10A-12J were produced by the strong broadband plasma emission.

For the 10 Hz laser ignition, higher per pulse energy was required to generate a plasma for heating the surrounding fuel/air mixture and initiating the ignition process, and the hot plasma was rapidly quenched within about 0.1 ms. FIGS. 10C-10E demonstrate a flame-front evolution that is very similar to that of a typical outwardly propagating spherical flame created by point spark ignition.

For the 10 kHz and 20 kHz laser ignition, the energy of each pulse energy was about 10 times weaker than the energy of each pulse used for the 10 Hz laser ignition. These results verify a 10 Hz laser having a pulse energy of less than 20 mJ/pulse generates the ionized plasma; however, that plasma is insufficiently dense to initiate an ignition process. The emission from the plasma created by the low energy laser pulse (less than 10 mJ/pulse) was weak and, after attenuation by the OH* band-pass filter, resulting emission could not be detected by the intensified camera.

For the 10 kHz and 20 kHz laser ignitions, the mixture built up to dense plasma after three-to-four consecutive laser pulses. Once the plasma was created, subsequent HRR laser pulses continued depositing energy so as to sustain and enhance the hot plasma for flame initiation and propagation. Based on the measurement of the strong emission from the hot plasma generated by the 10 kHz and 20 kHz laser, the plasma lifetime was found to be about 0.2 ms and about 0.3 ms, respectively, which is longer than the plasma lifetime of about 0.1 ms observed for 10 Hz laser. Extension of hot plasma lifetime leads to a greater ignition success rate. For all of the cases, the premixed flame finally stabilized on the burner surface after about 7 ms.

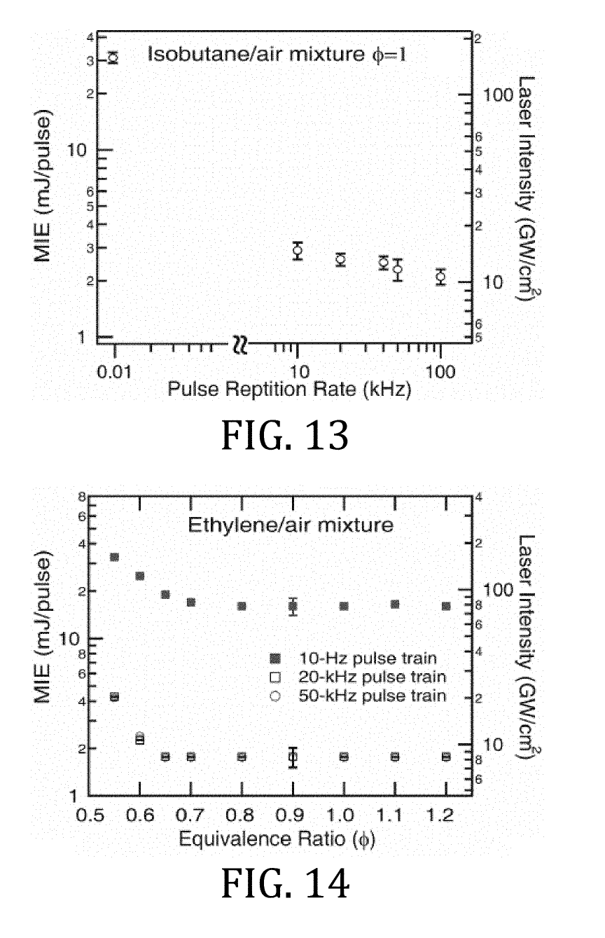

FIG. 13 graphically illustrates MIE as a function of pulse repetition rate (“PRR”) for the ignition of isobutane/air mixtures with equivalence ratio of 1 at atmospheric pressure. Here, MIE is defined as the minimal, input energy required to ignite the gas mixture with a probability of greater than 50% at a constant focusing condition. At 10 Hz, nanosecond lasers have a high MIE (about 30 mJ/pulse). MIE tends to decreases with increased PRR such that when PRR increases from 10 Hz to 10 kHz, MIE decreases by an order of magnitude. In particular, MIE decreases 10 to 12 times for PRR in the ranging from 10 kHz to 100 kHz. The total energy required for ignition was reduced by approximately a factor of two for HRR LI as compared to the low repetition rate of 10 Hz. Laser energy absorption by the resultant plasma increases from about 12% to about 40% when PRR increases from 10 Hz to 10 kHz. Laser energy absorption further increases from about 40% to about 60% when the PRR increases from 10 kHz to 100 kHz.

Those of ordinary skill in the art understand that plasma scattering contributes to about 3% to 4% energy loss. Therefore, these laser-absorption measurement suggest that the HRR LI approach deposits laser energy more efficiently to the plasma as compared to the low repetition rate LI approach. Once the PRR is at least 10 kHz, a required MIE remains within the same order of magnitude for higher PRRs. MIE cannot be decreased continuously with an increased PRR because in the HRR LI approach, the laser is required to operate above an intensity threshold for optical breakdown.

FIG. 14 graphically illustrates MIE as a function of equivalence ratio of the ethylene/air mixture at atmospheric pressure. For the HRR LI approach, the MIE was approximately constant across a wide equivalence-ratio range. The per-pulse energy decreased about 10 times for the HRR LI approach as compared to 10 Hz LI approach. Similar per-pulse ignition energies were observed for the 20 kHz and 50 kHz pulses, which implies a threshold energy must be met by front-running pulses for initial electron generation to compensate for heat losses and to yield reliable ignition.

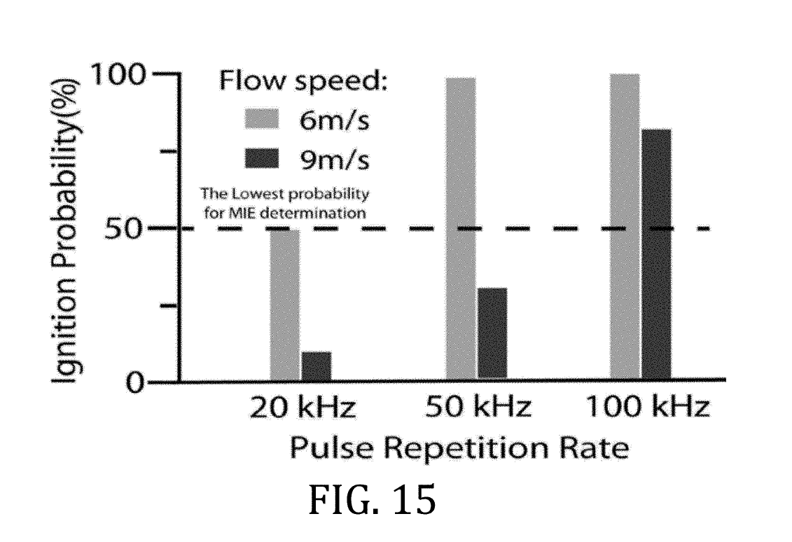

It is often challenging to achieve ignition in high-speed flows because of increased convective heat loss and flame blowout. FIG. 15 graphically illustrates an ignition probability of an isobutane/oxygen/nitrogen mixture by pulse trains having different repetition rates but constant energy per pulse (about 1.5 mJ/pulse). To achieve high-flow speed, a direct tube was used. FIG. 15 demonstrates an increase in PRR increases ignition probability at higher flow speeds. Ignition probability may be further increased using higher per pulse energy. It should be noted that, for FIG. 15, while the isobutene/oxygen/nitrogen mixture could be ignited using HRR pulses, the plasma could not be sustained because the flow speed was faster than the isobutane flame speed of about 0.3 m/s.

The various embodiments described herein provide for an LI system suitable for use in practical engines under high-speed flow, high-pressure, and fuel-lean conditions. Additional embodiments described herein provide for a fiber-coupled ignitor. Altogether, the embodiments significantly reduce a required per pulse laser energy for ignition, with a minimum pulse train being 5 or 6 pulses. Such embodiments enable transmission of pulse trains without risk of damage to optical fiber delivery systems. The embodiments are operable over a wide range of pressures, generally from atmospheric pressure (14 psia) to about 40 bar (560 psia).

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

1. A laser ignition system for igniting a plasma under fuel-lean and high-speed flows, the laser ignition system comprising:
a laser configured to generate pulses, wherein each pulse has a length ranging from about 10 ns to about 30 ns and a pulse energy ranging from about 10 mJ to about 20 mJ, and a pulse train comprising a plurality of the pulses with a repetition rate greater than 10 kHz;
a lens configured to focus the pulses toward a combustible fluid so as to ignite a plasma at the combustible fluid; and
a fiber optic cable extending between the laser and the lens.

2. The laser ignition system of claim 1, wherein a total energy of the pulse train is less than about 10 mJ.

3. The laser ignition system of claim 1, wherein the pulse energy is greater than about 1.5 mJ/pulse.

4. The laser ignition system of claim 3, wherein the pulse energy is greater than about 3 mJ/pulse.

5. The laser ignition system of claim 1, wherein each pulse has a wavelength of 532 nm.

6. The laser ignition system of claim 1, further comprising:
a controller configured to adjust at least one of the pulse length, the pulse energy, and the repetition rate.

7. The laser ignition system of claim 6, wherein the controller includes a polarizer, a half-wave plate, or both.

8. The laser ignition system of claim 1, further comprising:
a laser-to-fiber coupler between the laser and the fiber optic cable and configured to transfer the pulse train to optical transmission along the fiber optic cable.

9. An ignitor for use with a laser ignition system, the laser ignition system configured to generate pulses, wherein each pulse has a length ranging from about 10 ns to about 30 ns and a pulse energy ranging from about 10 mJ to about 20 mJ, and a pulse train comprising a plurality of the pulses with a repetition rate greater than 10 kHz, the ignitor comprising:
a fiber optic collimator configured to focus the pulse train to a desired plasma location;
a first optical fiber configured to transfer the pulse train from the laser ignition system to the fiber optic collimator; and
a first lens configured to isolate heat after a plasma is formed at the desired plasma location.

10. The ignitor of claim 9, wherein the first lens comprises sapphire, quartz, or glass.

11. The ignitor of claim 9, further comprising:
a first focus assembly between the first optical fiber and the fiber optic collimator.

12. The ignitor of claim 9, further comprising:
a second optical fiber configured to transfer microwaves;
a microwave wave guide configured to focus the microwaves onto a second lens.

13. The ignitor of claim 12, further comprising:
a second focus assembly between the second optical fiber and the microwave wave guide.

14. The ignitor of claim 12, wherein the second lens comprises sapphire, quartz, or glass.

15. The ignitor of claim 12, wherein the first and second lenses comprise a single lens.

16. The ignitor of claim 9, further comprising:
a housing having a first end, a second end, and a lumen extending therebetween,
wherein the fiber optic collimator, the first optical fiber, and the first lens are positioned within the lumen and proximate to the second end; and
a fiber optic coupler extending through the first end and configured to couple the first optical fiber to the laser ignition system.

17. The ignitor of claim 16, further comprising:
a second optical fiber positioned within the lumen and configured to transfer microwaves;
a microwave wave guide positioned within the lumen and configured to focus the microwaves onto a second lens positioned within the lumen and proximate to the second end.

18. The ignitor of claim 16, wherein the housing includes a plurality of channels configured to transmit a coolant.

19. The ignitor of claim 18, wherein the coolant is water, air, or nitrogen gas.

20-25. (canceled)
